(19) United States
(12) Patent Application Publication
(10) Pub. No.: US 2008/0025341 A1
(43) Pub. Date: Jan. 31, 2008

(54) METHOD AND SYSTEM FOR GRANTING OF CHANNEL SLOTS

(75) Inventors: Yadunandana N. Rao, Sunrise, FL (US); Apoorv Chaudhri, Sunrise, FL (US); Chet A. Lampert, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/461,326

(22) Filed: Jul. 31, 2006

(51) Int. Cl. H04J 3/22

(52) U.S. Cl. 370/468

(57) ABSTRACT

A system (100) and method (500) for method for channel slot granting is provided. The method includes estimating (502) a temperature of a device (102), adjusting (504) a duty-cycle of the device based on the temperature, sending (506) the duty-cycle to a base station (110) and allocating (510) time slots for the device in accordance with the duty-cycle. A rate of slot assignments to multiple devices can be controlled (512) based on multiple duty-cycles received. The duty-cycle and temperature can be included (610) in a Quality of Service (QoS) metric for inbound and outbound performance.

### FIELD OF THE INVENTION

This invention relates generally to a communications system, and more particularly to channel allocation.

### BACKGROUND OF THE INVENTION

The hand-held radio industry is constantly challenged in the market place for high audio quality, low-cost products which provide good reception and coverage. This further includes public safety data radios that are required to meet federal, state, and local public safety communications requirements. Public safety radios ensure proper use of radio communication resources and spectrum bandwidth. The public safety data radios can operate on the order of a few watts to enable wider coverage. However, this results in excessive heat dissipation within the device. The excessive heat dissipation can deteriorate communication performance and can generate interference affecting other radios. One approach to reduce the operating temperature, is to not use all time slots assigned to the radio. However, this results in a drop in overall system throughput since assigned slots goes unused. A need therefore exists for mitigating the effects of heat dissipation within a radio while maintaining system throughput and linear operating characterstics.

### SUMMARY OF THE INVENTION

Embodiments of the invention are directed to a method for channel slot granting. The method can include estimating a temperature of a device, adjusting a duty-cycle of the device based on the temperature, sending the duty-cycle to a system that manages communication with the device, and allocating time slots for the device in accordance with the duty-cycle. A rate of slot assignments granted to the device can be controlled based on duty-cycle updates received from the device. A QoS decision can be biased in view of the temperature for switching communication channels. For example, a measure of the temperature can be included in a Quality of Service (QoS) metric. The QoS metric can include measures for Radio Signal Strength, Receive Block Error Rate (BLER), duty-cycle, and the temperature. Channel switching can be limited in accordance with the temperature for identifying receiver performance errors due to temperatures of the device versus errors due to communication channel conditions.

Embodiments of the invention are also directed to a method for channel slot allocation. The method can include reading a temperature of a device, determining an adjustment in view of the temperature, changing a duty-cycle of the device in accordance with the adjustment, and sending the duty-cycle to a system in communication with a plurality of devices. The system can control a slot allocation to the device in accordance with the duty-cycle. The temperature can be compared to a threshold, and if the temperature exceeds the threshold, an adjustment can be performed to the duty-cycle. Moreover, the system can receive multiple duty-cycles from a plurality of devices and control a rate of slot assignments to the plurality of devices based on the duty-cycles received. The system can allocate slots to multiple devices in view of the multiple duty-cycles received.

A temperature measure can be also included in quality of service (QoS) metric to control site switching. A QoS decision can be biased to limit channel switching in accordance with the temperature measure. As one outbound example, a data request size can be specified in place of a duty-cycle for limiting outbound allocation if a QoS is unavailable. As an inbound example, a request priority can be speficied in place of a duty-cycle for controlling an inbound slot allocation if a QoS is unavailable.

Embodiments of the invention also include a system for channel slot granting. The system can include at least one device having a temperature detector for estimating a temperature of the device, and a controller for adjusting a duty-cycle of the device based on the temperature. The system can also include a base station in communication with at least one device, wherein the base station has a channel controller for controlling allocation of slots to at least one device in accordance with a duty-cycle. The system can further include a mobility manager for rating a Quality of Service (QoS) of a channel. The mobility manager can assess one or more QoS measures which include a duty-cycle and a measure of the temperature for determining whether to switch to another channel. The mobility manager can determine whether QoS measures are an indication of receiver performance due to a temperature of the device or due to communication channel conditions. In one aspect, the device can also ask for limited number of slots to maintain it's duty cycle and repeat the slot request every cycle. Overall system throughput may also be affected by non-linear operation of transmitter components in the device due to temperature causing high BLER leading to packet retries.

### BRIEF DESCRIPTION OF THE DRAWINGS

FIG. 1 is a diagram of a mobile communication system within a mobile communication environment;

FIG. 2 is a schematic of a mobile device in accordance with the embodiments of the invention;

FIG. 3 is an illustration of a duty-cycle in accordance with the embodiments of the invention;

FIG. 4 is a diagram of the mobile device of FIG. 2 in accordance with the embodiments of the invention;

FIG. 5 is a method for channel slot granting in accordance with the embodiments of the invention; and

FIG. 6 is a method for incorporating a temperature measure in a Quality of Service in accordance with the embodiments of the invention;

FIG. 7 is a flowchart for channel slot allocation in accordance with the embodiments of the invention.

### DETAILED DESCRIPTION OF THE DRAWINGS

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processor” can be defined as any number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

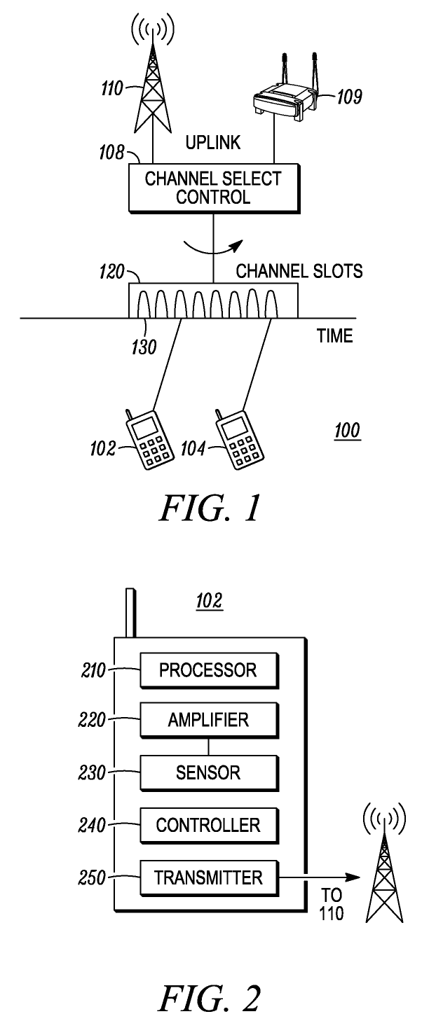

Referring to FIG. 1, a mobile communication system 100 for providing mobile communication is shown. The mobile communication system 100 can include one or more subscribers, such as mobile device 102 and mobile device 104. A mobile device can be a radio, a cell phone, a personal digital assistant, a mobile communication device, a public safety radio, a portable media player, an emergency communication device, or any other suitable communication device. As another example, the mobile device 110 can be a hand-held portable, bi-directional radio transceiver such as a walkie-talkie or a two-way radio. Characteristics of the mobile device 110 may include a half-duplex mode where one user can receive or transmit at a time, or may include a full-duplex mode allowing simultaneous two-way communication. Understandably, more than one mobile device can operate within the mobile communication environment for providing group call or dispatch communication.

The mobile communication system 100 can provide wireless connectivity over a radio frequency (RF) communication network such as a base station 110, also known as a tower. The base station may also be a base receiver, a central office, a network server, or any other suitable communication device or system for communicating with the one or more mobile devices. The mobile device 102 can communicate with one or more cellular towers 110 using a standard communication protocol such as Time Division Multiple Access (TDMA), Global Systems Mobile (GSM), or integrated Dispatch Enhanced Network (iDEN). The base station 110 can be part of a cellular infrastructure or a radio infrastructure containing standard telecommunication equipment as is known in the art.

In another arrangement, the mobile device 102 may also communicate over a wireless local area network (WLAN). For example the mobile device 102 may communicate with a router 109, or an access point, for providing packet data communication. In a typical WLAN implementation, the physical layer can use a variety of technologies such as 802.11b or 802.11g Wireless Local Area Network (WLAN) technologies. The physical layer may use infrared, frequency hopping spread spectrum in the 2.4 GHz Band, or direct sequence spread spectrum in the 2.4 GHz Band, or any other suitable communication technology.

In particular, the base station 110, or the router 109, can include, or be communicatively coupled to a channel select controller 108 for assigning time slots 120 to the plurality of mobile devices 102 and 104. In general, the base station 110 or the router 109 will be responsible for allocating time slots to the mobile devices. For example, the channel select controller 108 can assign a first time slot for mobile device 102, and a second time slot for mobile device 104. The mobile devices can transmit and receive data to and from the base station 110 to communicate with other mobile devices in accordance with their scheduled time slot. That is, a mobile device can communicate at a time corresponding to the time slot assigned. Notably, the base station 110 can assign time slots to a plurality of mobile devices that are already in communication with one another, or in a process of seeking communication with one another.

Briefly, the base station 110 provides a portion of a frequency spectrum as a frequency band such as UHF and VHF. As is known in the art, Very high frequency (VHF) is the radio frequency range from 30 MHz to 300 MHz. In contrast, Ultra high frequency (UHF) designates a frequency range between 300 MHz and 3.0 GHz. UHF frequencies' propagation characteristics are ideal for short-distance terrestrial communication such as radio communication. As one example, the UHF band can support the Family Radio Service (FRS) which is an improved two-way system or Public Safety Radio Services for providing emergency communication. As one example, within Public Safety Radio, the base station 110 can support 25 KHz bandwidth channels within a 700-800 MHz carrier frequency range. Embodiments of the invention are not however limited to the radio frequency bands and can include frequency bands associated with other TDMA systems.

Referring directly to FIG. 1, there may only be a given number of total time slots 120 that the base station 110 can assign to a plurality of mobile devices. For example, the base station 110 may be able to allocate only a certain number of slots 130 based on a number of users, the bandwidth for each time slot, and the total bandwidth available to the base station 110. Accordingly, the base station may assign time slots in a round-robin fashion based on a usage of the time slots. For example, mobile device 102 may be assigned its own time slot schedule for transmitting and receiving data. Mobile device 104 may be assigned its own time slot schedule for transmitting and receiving data. However, there may be times when the mobile device 102 elects not to send or receive data at the assigned time slot. For example, the mobile device 102 may overheat and elect not to send data at the corresponding time slot. Accordingly, the time slot is un-used and the bandwidth assigned to the mobile device 102 is sacrificed.

In order to conserve bandwidth resources, mobile device 102 can establish a schedule for using time slots that it conveys to the base station for informing the base station of the slots it will use. In these situations the base station 110 can re-assign the time slots to other mobile devices, such as mobile device 104, for allowing the mobile devices 104 to communicate on the otherwise un-used time slot. The mobile device 102 establishes the schedule in view of one or more mobile device parameters that affect communication performance. In particular, a measure of device temperature can be evaluated for adjusting the schedule, thereby mitigating communication performance losses due to overheating while concurrently preserving bandwidth resources by informing the base station of the schedule. Specifically, the channel select controller 108 cooperatively communicates with the plurality of mobile devices to assign time slot based on the schedule established and provided to the base station 110 by the mobile device 102.

Referring to FIG. 2, a schematic of the mobile device 102 is shown. The schematic is also representative of the components in the other mobile devices within the mobile communication environment of FIG. 1. In particular, the schematic identifies components associated with transmitting a communication and measuring a device temperature. The mobile device 102 can include a processor 210 for providing signal processing functions associated with communication, an amplifier 220 for amplifying one or more communication signals generated or received by the mobile device, a sensor 230 operatively coupled to the amplifier 220 for measuring a temperature of the amplifier 220, a controller 240 for adjusting a duty-cycle, and a transmitter 250 for transmitting one or more signals to the base station 110. In one arrangement, the processor 210, the amplifier 220, and the transmitter 250 can provide modulation and demodulation functionality (e.g. modem processes). For example, the processor can modulate a base-band signal to a carrier frequency, the amplifier 220 can increase a gain of the modulated signal, and the transmitter can include physical layer synchronization and timing for transmitting the modulated signal at the assigned time slot 130 (See FIG. 1). Alternatively such components may exist in the device together as a separate chip, such as a modem component.

Briefly, the amplifier 220 may be a high gain power amplifier for transmitting communication signals over far distances to the base station 110 (See FIG. 1). The amplifier 220 may rise in temperature in response to demands on the processor 210, the transmitter 250, or other components within the mobile device 102. For example, during inbound communication, wherein the mobile device 102 is transmitting data inbound to the base station 110, increases in temperature can cause power amplifier nonlinearities that result in spectrum leakage and reduced inbound throughput. That is, excessive transmitting can raise the temperature of the amplifier which may adversely affect transmit performance and cause harmful interference for other subscribers. The sensor 230 can measure a temperature of the amplifier 220, and the controller 240 can adjust a duty-cycle of the mobile device in accordance with the temperature. Notably, the duty-cycle identifies transmit and receive time slots 120 (See FIG. 1) for the mobile device 102. For example, the controller can decrease a transmission period when increasing temperatures are detected. By transmitting less often, the device may lower in temperature. It should also be noted that the sensor 230 is not limited to only measuring the temperature of the amplifier. The sensor 230 can also measure a temperature of other components within the mobile device which may affect communication performance.

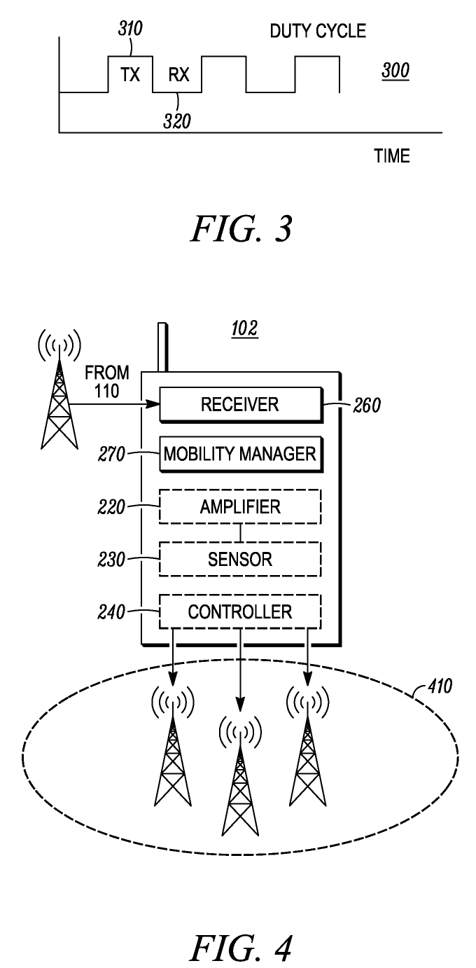

Referring to FIG. 3, a duty-cycle 300 for the mobile device 102 is shown. For example, the duty-cycle 300 describes a timing schedule for transmitting and receiving at the mobile device 102. The mobile device 102 transmits at a transmit time 310, and receives at a receive time 320. Briefly referring back to FIG. 2, the controller 240 can adjust the duty-cycle 300 in view of one or more temperature readings provided by the sensor 230. Notably, the duty-cycle 300 transmit 310 and receive 320 times correspond with time slots 120 assigned by the base station 110 to the mobile device 102. For example, the transmit 310 and receive 320 times occur at periods coinciding with one or more time slots 120 assigned by the base station. The duty-cycle 300, as a result of timing adjustments by the controller 240 due to temperature readings, provides an indication of transmit and receive times that are optimal to the mobile device in view of operating performance. That is, the mobile device 102 can adjust its own duty-cycle 300 in accordance with self monitored temperature readings to determine a schedule for transmitting and receiving based on optimal device performance.

Referring to FIG. 4, the schematic for the mobile device 102 of FIG. 2 is shown with more components. In particular, the schematic presents components associated with receiving a communication in addition to measuring a temperature. The mobile device 102 can include a receiver 260 for receiving communication, and a mobility manager 270 for rating a Quality of Service (QoS) of a channel. In particular, the mobility manager 270 assess one or more QoS measures for determining whether to switch to another channel. The QoS measures can include the duty-cycle or the temperature reading.

Briefly, higher temperatures in the amplifier 220 can deteriorate receiver 260 performance, also known as outbound performance—wherein the radio receives data outbound from the base-station. For example, higher temperatures in the receiver 260 as a result of the amplifier 220 temperature can cause clock drift, introduce thermal noise, cause front end filter variations, and affect other hardware lineup entities. The effects can introduce communication errors in the receiver 260, As one example, the receiver 260 may include a receive block error rate (BLER) that identifies bits received in error. As an example, the BLER may include a parity check or a cyclic redundancy check (CRC) for determining which bits in the communication signal are possibly received in error. However the errors may be due to temperature increases in the mobile device, and not due to the communication channel.

In practice, the BLER evaluates bit error rates, and informs the controller 240 when the bit errors exceed a threshold. In response, the controller 240 searches other base stations 410 in order to improve a channel quality of service. Switching to other base stations 410 is an accepted procedure when bit error rates are sufficiently high to degrade a quality of service, such as the number of correct bits received or a bandwidth capacity. However, high amplifier 220 temperatures can inadvertently cause the BLER to report falsely high error rates. That is, the error rates may be due to receiver errors as a result of higher temperature rather than to the channel conditions. In general, the BLER identifies bit errors resulting from channel conditions such as interference and fading. However, the BLER may mistakenly report bit errors due to high receiver devices as a result of clock drift or thermal noise. Consequently, switching channels to due false BLER readings will not improve quality of service. Consequently, channel switching will not improve quality of service given that the problems are not with the channel, but with the receiver due to high temperatures. Subsequently, unnecessary channel switching may continually occur since the BLER rates are artificially high.

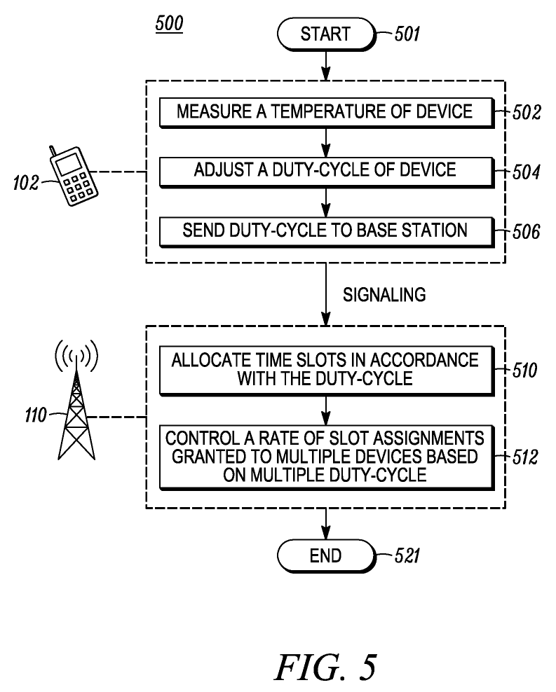

Referring to FIG. 5, a method 500 for channel slot granting is shown. To describe the method 500, reference will be made to FIGS. 1, 2 and 3 although it is understood that the method 500 can be implemented in any other suitable device or system using other suitable components. Moreover, the method 500 is not limited to the order in which the states are listed in the method 500. In addition, the method 500 can contain a greater or a fewer number of states than those shown in FIG. 5.

At step 501, the method 500 can begin. As an example, the method 500 can begin on the mobile device 102. At step 502, a temperature of the device can be measured. For example, referring to FIG. 2, the sensor 230 can measure a temperature of a component of the device, such as the amplifier 220. The sensor can read the temperature via software and sample the temperature readings of the device at regular time intervals. At step 504, a duty-cycle of the mobile device can be adjusted. For example, referring to FIG. 2, the controller 240 can adjust the duty-cycle 300 (See FIG. 3) of the mobile device 102 in accordance with the temperature. In practice, the controller 240 can compare the temperature to a threshold, and if the temperature exceeds the threshold, the controller 240 can perform an adjustment of the duty-cycle 300. Else, if the temperature does not exceed the threshold, the controller 240 dos not perform an adjustment of the duty-cycle 300. For instance, the controller 240 can increase the duty-cycle 300 to lengthen time periods between transmissions or receptions upon the sensor 230 detecting increasing temperatures. Similarly, the controller 240 can decrease the duty-cycle for decreasing temperatures, if necessary. At step 506, the device can send the duty-cycle to the base station. As one example, referring to FIG. 2, the mobile device 102 can send the adjusted duty-cycle 300 to the base station 110, or an adjustment of the duty-cycle 300 to the base station.

At step 510, time slots can be allocated in accordance with the duty cycle. For example, referring to FIG. 2, the base station 110 can receive the duty-cycle 300 from the mobile device 102 and assign a time slot to the mobile device 102 in accordance with the duty-cycle. Moreover, the base station 110 can receive multiple duty-cycles from a plurality of devices, and control a rate of slot assignments to the plurality of devices based on the duty-cycles received. Notably, the system allocates time slots in view of the multiple duty-cycles to maximize an allocation of infrastructure resources used in supporting the communication to the mobile device 102, or mobile devices.

At step 512, a rate of slot assignments granted to the device can be controlled based on the duty-cycle. For example, referring to FIG. 1, the channel controller 108 can assign time slots 120 to the mobile device 102 and 104 based on one or more duty-cycles received from the devices. That is, the base station 110 can schedule the time slots in accordance with the duty cycles of the devices, wherein the duty cycles are adjusted based on at least a temperature of the mobile device. Moreover, devices reporting lower duty-cycles can be assigned fewer slots over a longer period of time, and devices reporting higher duty-cycles can be assigned more slots over a shorter period of time. Furthermore, the channel controller 108 coordinates time slots in view of duty-cycle updates sent by the devices. At step 521, the method 500 can end.

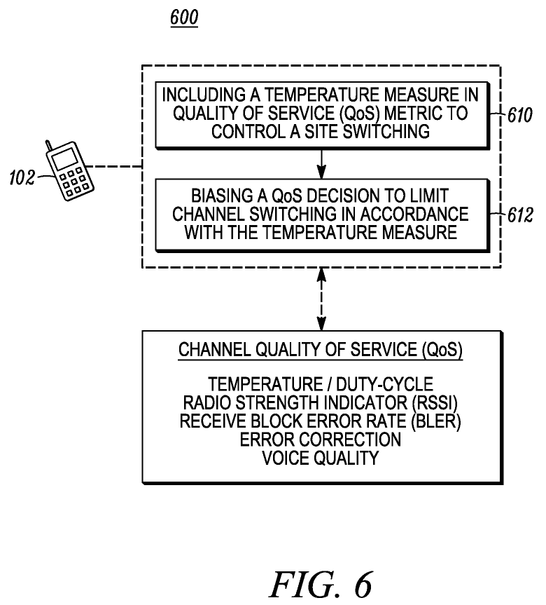

Referring to FIG. 6, a method 600 for channel switching is shown. To describe the method 600, reference will be made to FIGS. 1, 3 and 4 although it is understood that the method 600 can be implemented in any other suitable device or system using other suitable components. Moreover, the method 600 is not limited to the order in which the states are listed in the method 600. In addition, the method 600 can contain a greater or a fewer number of states than those shown in FIG. 6. In particular, the method 600 can be employed on the mobile device 102 for controlling a site switching behavior during receive mode (e.g. outbound) in response to determining a temperature.

At step 610, a temperature measure can be included in a (QoS) metric to control a site switching. A QoS metric may include session-based QoS parameters such as throughput rate, delay, reliability, and precedence. The mobile device can assess the QoS parameters to determine a channel quality of service available to the mobile device during the session. Referring to FIG. 4, the mobility manager 270 can include a Quality of Service (QoS) metric that can adjust a duty-cycle based on Radio Signal Strength Indication (RSSI), Block Error Rate (BLER), Voice Quality, and Error Correction. The QoS metric can be extended to include duty-cycle and temperature as shown in FIG. 6.

Recall, the mobility manager 270 (See FIG. 4) attempts to locate new cell towers (410) when a channel quality of service to the device deteriorates. For example, the mobility manager 270 in a public safety radio may include measures for Radio Signal Strength Indication (RSSI) and BLER. The mobility manager 270 can evaluate changes in the RSSI and BLER and perform site switching in response to the RSSI and BLER measures. However, the channel quality of service may deteriorate due to the effects of high temperature on the device rather than channel conditions such as interference and fading. Accordingly, the duty-cycle or temperature measure is included within the Quality of Service (QoS) metric. That is, the mobile device 102 incorporates a measure of the duty-cycle or temperature in the QoS metric in order to mitigate unnecessary site switching. In practice, public safety radios can be extended to include QoS measures for RSSI, BLER, and device temperature as key issues for providing and monitoring mobility. Understandably, the mobile manager 270 is only a descriptive component for controlling site switching behavior. Embodiments of the invention may include the QoS measures in another controlling device or in another operative manner.

At step 612, a QoS decision can be biased to limit channel switching during receive mode in accordance with the temperature measure. Limiting channel switching prevents unnecessary searching of cell sites and conserves power. Briefly, referring to FIG. 4, the mobility manager 270 can determine whether QoS measures are an indication of receiver performance due to a temperature of the device or due to communication channel conditions. The mobility manager 270 can be operatively coupled to the sensor which reports a temperature of the mobile device 230. The mobility manager 270 can also be operatively coupled to the controller for 240 for adjusting a duty-cycle. When the temperature exceeds a predetermined threshold, the controller 240 can increase a duty cycle 300 (See FIG. 3) to increase a receive period and send the duty-cycle 300 to the base station 110. The base station 110 can evaluate the duty cycle 300 and change the receive time slots to the mobile device 102. In particular, the channel controller 108 (See FIG. 1) that is cooperatively coupled, or connected, to the base station 110 controls a slot assignment rate based on duty-cycles received from a plurality of devices. Devices reporting lower duty-cycles are assigned fewer slots over a longer period of time, and devices reporting higher duty-cycles are assigned more slots over a shorter period of time. This allows the base station to re-assign un-used slots to other devices.

In the description of FIG. 6, it was noted that a mobile device having a QoS mechanism can be complemented to include a measure of duty-cycle or temperature to limit site switching behavior. It should be noted that the QoS mechanism may already provide a protocol to communicate data to one or more base stations. That is, mechanisms may already be in place which allows a mobile device to send data to the base station. Accordingly, the duty-cycle and temperature can be sent as a QoS measure to a base station. In response, the base station can adjust slot allocations to the device based on the duty-cycle and/or temperature measure.

It should also be noted that some mobile device, such as High Performance Data (HPD) radios and High Speed Data (HSD) radios may not include a QoS mechanism. Accordingly, the device may not have resources to communicate with the base station to adjust a frame rate based on one or more measures. Accordingly, a duty-cycle or temperature measure can be included within devices that do not provide an ability to inform the base station (e.g. QoS mechanism). For example, the mobility manager 270 can control a size of data requested from the base station instead of only requesting a slot allocation rate change. That is, the mobile device 102 can specify a data request size in place of a duty-cycle or temperature for limiting outbound allocation. The slot assignments do not change, though the sizes of the packets within the slot are decreased to reduce an operating temperature of the mobile device. For instance, the mobile device 102 can adjust a request packet size in response to a change in temperature.

Moreover, in both HPD and General Packet Radio Systems (GPRS), resource-grant mechanism may be used for inbound data transmission (Note, the previous discussion centered on outbound transmission). That is, the base station may use a scheduling mechanism to reserve slots. In the case of HPD, the mobile device 102 transmits a resource request specifying number of slots or blocks required using (Random Access Channel Control) RACH. The number of slots requested is acknowledged by the base station 110 and which specifies the number of slots/blocks granted. Then the base station 110 grants and notifies the reserved slots to specific mobile device 102 on slot by slot basis using a round robin scheduler. Accordingly, the duty cycle of slots assigned to a mobile device depends upon number of mobile devices to be serviced at that time. In certain systems (e.g. base stations), a QOS mechanism may be lacking and only a priority of a request can be used to handle temperature based duty cycle control. Accordingly, the base station can change a priority request in response to a change in duty-cycle request for mitigating temperature effects on the mobile device.

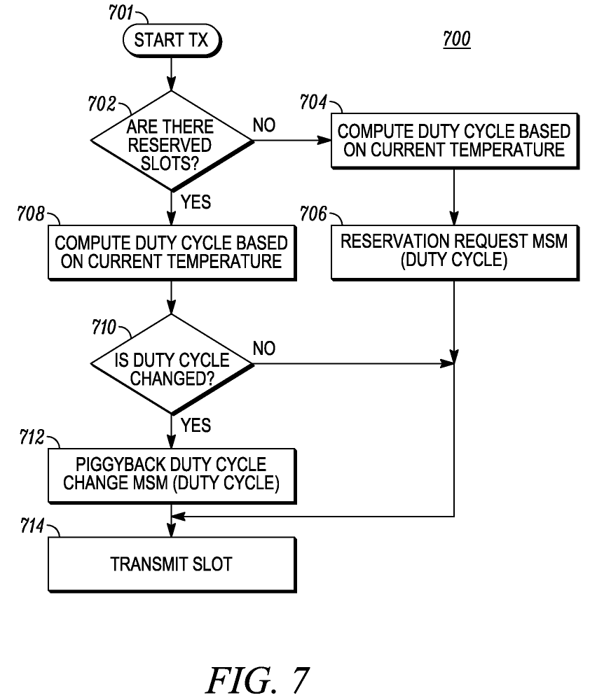

Referring to FIG. 7, a flowchart 700 for channel slot allocation of a mobile device is shown. To describe the flowchart 700, reference will be made to FIGS. 1, 3 and 4 although it is understood that the flowchart 700 can be implemented in any other suitable device or system using other suitable components. Moreover, the flowchart 700 is not limited to the order in which the states are listed in the flowchart 700. In addition, the flowchart 700 can contain a greater or a fewer number of states than those shown in FIG. 7. The flowchart can start in a state wherein a mobile device is in communication with a base station.

At step 701, the mobile device can start transmission. At step 702, a determination can be made as to whether reserved slots are available. For example, referring to FIG. 1, the base station 110 can inform the mobile device 102 of slots that are in use (i.e. reserved). If there are un-used slots, at step 704, the mobile device can compute a duty-cycle based on a current temperature. For example, referring to FIG. 2, the sensor 230 can measure a temperature of the amplifier 220, and the controller 240 can calculate the duty-cycle 300 in accordance with the temperature (See FIG. 3). At step 706, a reservation request MSM including the duty-cycle can be sent to the base station. For example, the mobile device 102 can include the duty-cycle within the MSM request to the base-station. At step 714, the mobile device can transmit the slot. For example, referring to FIG. 2. the transmitter 250 can send the duty-cycle in an MSM to the base station 110.

If there are used slots, at step 708, the mobile device can also compute a duty-cycle based on a current temperature. At step 710, a change in the duty cycle can be determined. For example, referring to FIG. 2, the controller 240 can determine if the duty-cycle has changed in response to a change in temperature. If the duty-cycle is unchanged, the mobile device can continue transmission at the current slot rate set by the base station. That is, it does not need to request the base station to change the slot assignments. If the duty-cycle has changed, at step 712, the mobile device can include a duty-cycle change with a reservation request MSM. Notably, the mobile device 102 may elect to send a change in the duty-cycle, or send the actual duty-cycle. In either case, the base station 110 can adjust a slot allocation in view of the updated duty-cycle.

Notably, when the temperature exceeds a certain threshold, which may be a predefined system parameter, the following actions are generally performed: the transmit duty cycle is reduced based on preset thresholds, and the mobile device reports the current duty cycle to the base station. The duty-cycle can be sent along with other signaling messages such as the MSM, or with its own signaling message. The steps of flowchart 700 can be applied to multiple devices in communication with the base station. The base station can receive the duty cycle information from all the active mobile devices. The base station can control rate of assignment of slots in view of the duty-cycles requested by the mobile devices. Moreover, notably, a QoS mechanism can be centralized and controlled at a base station for increasing inbound performance, or can be decentralized to a mobile device for increasing an outbound performance.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not limited. Numerous modifications, changes, variations, substitutions and equivalents will occur to those skilled in the art without departing from the spirit and scope of the present embodiments of the invention as defined by the appended claims.

What is claimed is:

1. A method for channel slot granting, comprising:
estimating a temperature of a device;
adjusting a duty-cycle of the device based on the temperature; and
allocating time slots for the device in accordance with the duty-cycle,
wherein the duty-cycle establishes transmit and receive data rates for the device to communicate in accordance with the time slots.

2. The method of claim 1, further comprising:
sending the duty-cycle to a system that manages communication with the device, and, at the system,
allocating time slots in accordance with the duty-cycle.

3. The method of claim 2, further comprising:
controlling a rate of slot assignments granted to the device based on duty-cycle updates received from the device,
wherein the system allocates slots in accordance with the duty-cycle updates.

4. The method of claim 1, further comprising:
including a temperature measure in a Quality of Service (QoS) metric and biasing a QoS decision for switching communication channels,
wherein the QoS metric includes measures for Radio Signal Strength, Receive Block Error Rate (BLER), duty-cycle, and temperature.

5. The method of claim 4, wherein the biasing a QoS decision includes:
limiting channel switching in accordance with the temperature measure, for informing the QoS metric that QoS measures are an indication of receiver performance due to a temperature of the device and not due to communication channel conditions;

6. The method of claim 1, wherein the estimating a temperature includes estimating a temperature of a power amplifier of the device, wherein the power amplifier transmits and receives data in accordance with the duty cycle.

7. The method of claim 1, wherein devices reporting lower duty-cycles are assigned fewer slots over a longer period of time, and devices reporting higher duty-cycles are assigned more slots over a shorter period of time.

8. The method of claim 2, wherein the system is at least one of a base station, a base receiver, a mobile base station, a central office, a router, or an access point.

9. The method of claim 1, further comprising:
computing a duty-cycle based on a current temperature;
determining whether slots are available,
if slots are available,
requesting a slot reservation based on the duty-cycle;
if slots are reserved,
determining whether there is an adjustment in the duty-cycle;
and
if there is an adjustment;
adjusting the slot rate; and
including the adjustment in a request for a slot reservation.

10. A method for channel slot allocation, comprising:
reading a temperature of a device;
determining an adjustment in view of the temperature;
changing a duty-cycle of the device in accordance with the adjustment; and
sending the duty-cycle to a system in communication with a plurality of devices,
wherein the system controls a slot allocation to the device in accordance with the duty-cycle.

11. The method of claim 10, wherein the estimating the temperature includes:
sampling temperature readings of a power amplifier; and
generating a temperature measure based on the sampling.

12. The method of claim 10, wherein the determining an adjustment includes:
comparing the temperature to at least one threshold; and
if the temperature exceeds the threshold, performing an adjustment of the duty-cycle, else
if the temperature does not exceed the threshold, not performing an adjustment of the duty-cycle.

13. The method of claim 10, further comprising, at the system:
receiving multiple duty-cycles from a plurality of devices;
controlling a rate of slot assignments to the plurality of devices based on the duty-cycles received,
wherein the system allocates slots in view of the multiple duty-cycles.

14. The method of claim 10, further comprising:
specifying a request priority in place of a duty-cycle for controlling an inbound slot allocation.

15. The method of claim 10, further comprising:
Including a temperature measure in quality of service (QoS) metric to control a site switching; and
biasing a QoS decision to limit channel switching in accordance with the temperature measure,
wherein the device searches for base stations in accordance with the QoS metric.

16. The method of claim 15, further comprising:
specifying a data request size in place of a duty-cycle for limiting outbound allocation.

17. A system for channel slot granting, comprising:
at least one device having a:
a temperature detector for estimating a temperature of the device; and
a controller for adjusting a duty-cycle of the device based on the temperature; and,
a base station in communication with the at least one device, wherein the base station has a channel controller for controlling an allocation of slots to the at least one device in accordance with the at least one duty-cycle.

18. The system of claim 17, wherein the at least one device includes:
a receiver for receiving data at a rate corresponding to the at least one duty-cycle, and
a transmitter for transmitting data at a rate corresponding to the at least one duty-cycle and sending a measure of the temperature to the base station; and
wherein the duty cycle establishes transmit and receive data rates for the at least one device.

19. The system of claim 17, wherein the at least one device further includes:
a mobility manager for rating a Quality of Service (QoS) of a channel, wherein the mobility manager assess one or more QoS measures that include a measure of the temperature for determining whether to switch to another channel,
wherein the mobility manager determines whether QoS measures are an indication of receiver performance due to a temperature of the device or due to communication channel conditions.

20. The system of claim 17, wherein the channel controller controls a rate of assignment of slots based on duty-cycles received from a plurality of devices such that devices reporting lower duty-cycles are assigned fewer slots over a longer period of time, and devices reporting higher duty-cycles are assigned more slots over a shorter period of time, for re-assigning un-used slots to other devices.
